(19) United States
(12) Patent Application Publication
(10) Pub. No.: US 2026/0027844 A1
(43) Pub. Date: Jan. 29, 2026

(54) ADVANCING MEDIA TRAILING EDGES

(71) Applicant: HEWLETT-PACKARD DEVELOPMENT COMPANY, L.P., Spring, TX (US)

(72) Inventors: Pablo ARTEAGA DEL ARCO, Sant Cugat del Valles (ES); Josep Maria BEL CALAVIA, Sant Cugat del Valles (ES); Martin URRUTIA NEBREDA, Sant Cugat del Valles (ES)

(73) Assignee: HEWLETT-PACKARD DEVELOPMENT COMPANY, L.P., Spring, TX (US)

(21) Appl. No.: 18/994,199

(22) PCT Filed: Jul. 15, 2022
(86) PCT No.: PCT/US2022/037355

§ 371 Date: Jan. 14, 2025

(51) Int. Cl. B41J 11/42; B41J 11/00

(52) U.S. Cl. CPC B41J 11/42; B41J 11/0095

(57) ABSTRACT

Examples include a method where position data of a media advancing within a print zone are received at a printer controller and from a media advance sensor. An advance of the media by an upstream media advance mechanism located upstream from the print zone is controlled by the printer controller during a first time period. The advance of the media by a downstream media advance mechanism located downstream from the print zone is controlled by the printer controller during a second time period following the first time period and in function of the received position data, whereby a trailing edge of the media passes between the upstream media advance mechanism and the downstream media advance mechanism during the second time period.

### BACKGROUND

This disclosure generally relates to the printing and advancing of media within a printer. The media may be in the form of a continuous sheet or a cut sheet. Printing and advancing of the media can be provided by various types of printheads and advancing mechanisms.

### BRIEF DESCRIPTION OF THE DRAWINGS

FIG. 1 illustrates an example method.

FIG. 2 illustrates another example method.

FIG. 3 illustrates another example method.

FIG. 4 illustrates another example method.

FIG. 5 illustrates another example method.

FIG. 6 illustrates another example method.

FIG. 7 illustrates an example printer.

FIG. 8 illustrates another example printer.

FIG. 9 illustrates another example printer.

FIG. 10 illustrates another example printer.

FIG. 11 illustrates another example printer.

### DETAILED DESCRIPTION

Printing on a media and advancing the media are two related processes that should be synchronized to provide high-quality printing. The media may be in the form of a continuous sheet or a cut sheet. As an example of printing, a printhead ejecting a printing fluid on a media may be used. Other methods of printing may be also used. During printing, a precise advance of the media helps to provide a high-quality graphical representation with a reduced number of, or without, undesired artifacts. The advance of the media can be provided by various types of advance mechanisms located upstream from a print zone to advance the media towards such print zone. However, once a trailing edge of the media is within the print zone, the absence of advance mechanisms within the print zone, causes that the printer may not be capable to print on the trailing edge of the media with acceptable quality due to the lack of media advance control, leading to generating on the trailing edge of the media a significant unprinted margin. The purpose of the present disclosure is to overcome the limitation of not being able to print on the trailing edge of the media thereby reducing the waste of material and lowering the overall cost of printing.

The media of the present disclosure should be understood as a generally two-dimensional printing media having a width, a length, and a thickness. The thickness is very significantly smaller than both the width and the length, the thickness may be, for example, less than 100 times smaller than the length or width. The media may be provided as a continuous sheet or a cut sheet. The media may comprise cellulose fiber, polymeric fibers, natural fibers, or a combination of these. The media may be a laminate. The media may be a paper-based media or a textile media, being a woven or non-woven textile media. In some examples, the media is provided in the form of a roll.

In the following detailed description, reference is made to the accompanying drawings. The examples in the description and drawings should be considered illustrative and are not to be considered as limiting to the specific example or element described. Multiple examples may be derived from the following description and/or drawings through modification, combination, or variation of certain elements.

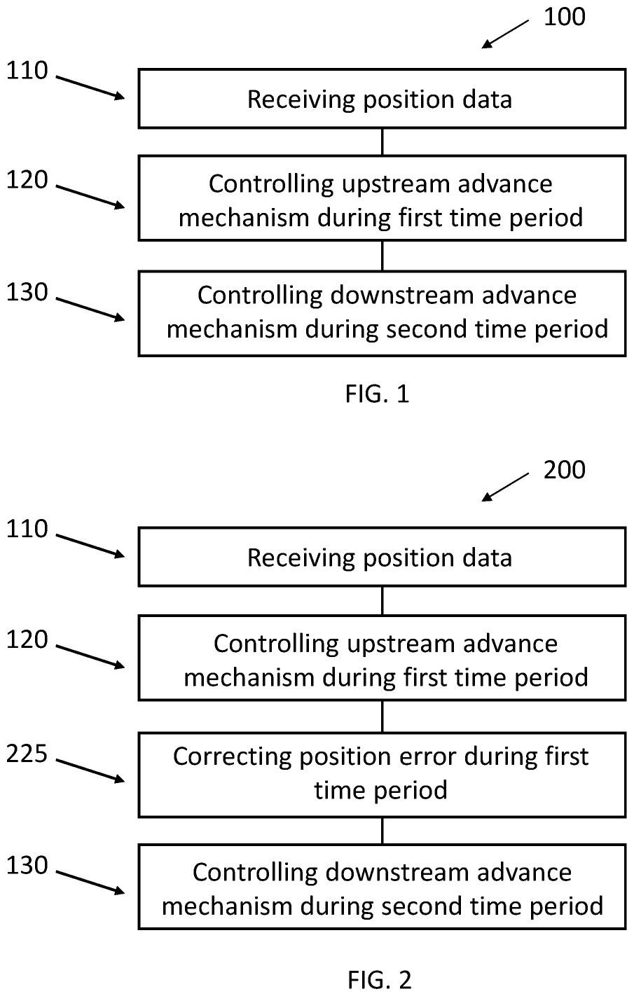

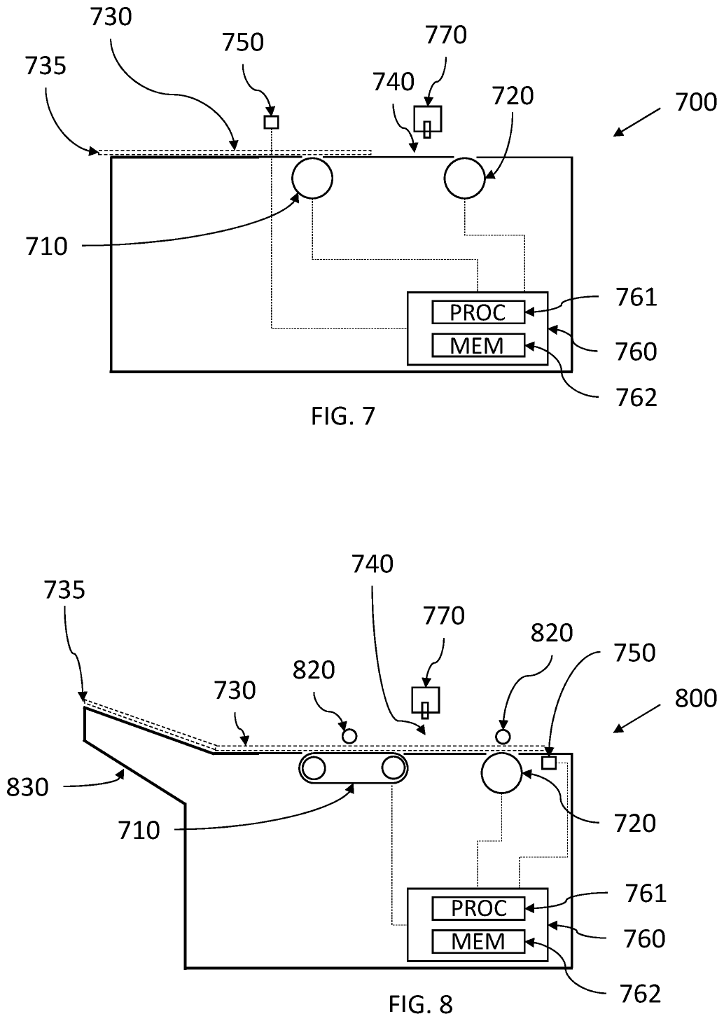

FIG. 1 illustrates an example method 100 of the present disclosure which may for example be operated using any of example printers 700, 800, 900, 1000 or 1100 described in FIGS. 7 to 11, the method comprising, in block 110, receiving, at a printer controller 760 and from a media advance sensor 750, position data of a media 730 that is at least partially positioned within a print zone 740.

The printer controller 760 of the present disclosure should be understood as any controller that comprises a processor 761 and a memory 762. The processor 761 is configured to operate according to any of the methods hereby described. The processor 761 may comprise electronic circuits for computation managed by an operating system. The processor 761 may perform as per any of the methods described based on a non-transitory machine-readable storage medium, such as, for example, the memory 762, whereby the non-transitory machine-readable storage medium is encoded with instructions executable by the processor 761. The non-transitory machine-readable storage medium may be any electronic, magnetic, optical, or other physical storage devices that store executable instructions. The non-transitory machine-readable storage medium may be, for example, Random Access Memory (RAM), an Electrically Erasable Programmable Read-Only Memory (EEPROM), a storage drive, an optical disk, and the like.

The media advance sensor 750 of the present disclosure should be understood as any sensor that measures the advance (movement) of the media 730 while the media 730 advances through the print zone 740. The media advancement sensor 750 may be controllable to measure the real advance of the media 730 at the locations in which the media advancement sensor 750 is located thereto. The media advancement sensor 750 may be any sensor suitable for measuring the advance of the media 730, for example by measuring movement, displacement, position, velocity and/or acceleration. Examples of the media advancement sensor 750 may include an optical sensor (e.g., Optical Media Advance Sensor (OMAS), camera) or a mechanical sensor (e.g., rotary encoder). The media advancement sensor 750 may be located above or below the media 730. In some examples of mechanical sensors, the sensor may further comprise a rotatory encoder or a shaft encoder to read the real advance of the media 730. In some examples, the media advance sensor 750 may proceed with the sensing mechanically, by contact or by force sensing with the media 730, or may proceed with the sensing of electromagnetic radiation, for example through ultrasound, infrared or visible light. According to other examples, the media advance sensor 750 may be the Optical Media Advance Sensor (OMAS) that may be a stationary sensor, being for example placed below, for example below and within, or below and downstream from, the print zone 740. The OMAS may measure the movement of the media 730 from the backside of the media 730 while the media 730 advances through the print zone 740. The OMAS may use microscopic structures on the surface of the media 730 for alignment. The sensor 750 may be connected to the printer controller 760 wirelessly or by a wire to exchange digital or analog data with the printer controller 760, such data being related to the advance of the media 730.

The print zone 740 of the present disclosure should be broadly understood as comprising a printing area between an upstream media advance mechanism and a downstream media advance mechanism, printing area in which the printing takes place, in particular comprising an area in which the printing fluid reaches the media, as well as an upstream area directly leading to the printing area, and a downstream area directly following the printing area. In this context, upstream should be understood as prior to printing, or prior to the printing fluid reaching the media, and downstream should be understood as following printing, or after the printing fluid reaching the media The upstream area, printing area, and downstream area follow each other in this order along a media advance direction. The media advance direction should be understood as the direction of movement of the media 730 during printing. For example, the media advance direction may be the direction from the upstream area, through the print zone and to the downstream area, in this order.

In block 110 of the example method 100, position data of the media 730 that is at least partially positioned within the print zone is received from the media advance sensor 750, at the printer controller 760. The position data should be understood as any data related to the position of the media 730, such data being capable to indicate the advancing of the media 730 within the print zone 740, such as a position of the leading edge of the media 730, a position of the trailing edge 735 of the media 730, or a position of any part of the media 730 to determine advancing of the media 730 within the print zone 740. Media advancement should be understood as advancement of the media along the media advance direction. Such data may be received from the media advance sensor in the form of raw data for further processing at the controller, or may be pre-processed by the media advance sensor prior to being transmitted to the controller in order to free-up processing bandwidth at the printer controller level.

A media at least partially positioned within the print zone should be understood as a media comprising at least a portion within the print zone. Such portion may comprise one of a leading edge, a trailing edge, or a portion located between the leading edge and the trailing edge.

Referring to FIG. 1, the example method 100 comprises, in block 120, controlling, by the printer controller 760, and during a first time period, an advance of the media 730 by an upstream media advance mechanism 710 located upstream from the print zone 740.

The upstream media advance mechanism 710 of the present disclosure should be understood as any type of advance mechanism that is capable of advancing the media 730, located upstream from the print zone 740. In some examples, the upstream media advance mechanism 710 may comprise, for example, one or more of a roller, a drive wheel, a belt, and a conveyor. In some examples, the upstream media advance mechanism 710 may feed unprinted media 730 towards the print zone 740. In other examples, the upstream media advance mechanism 710 may feed pre-printed media 730 towards the print zone 740. The upstream media advance mechanism 710 may be connected to the printer controller 760 wirelessly or by a wire to exchange digital or analog data with the printer controller 760, such data being related to the advance of the media 730.

Controlling should be understood as providing a control signal from the printer controller 760 to the media advance mechanism(s) in order to reach a desired media advance precision, in some examples without feedback from the media advance sensor 750. In some examples, the advance (movement) of the media advance mechanism may be controlled directly by the printer controller 760, without considering the position data from the media advance sensor 750. For example, the printer controller 760 may provide a control signal to the upstream media advance mechanism 710 to control its advance. Such interaction between the printer controller 760 and the upstream media advance mechanism 710 demands less computing power than the incorporation of the feedback signal from the media advance sensor 750. Controlling the advance of the upstream media advance mechanism 710 without feedback from the media advance sensor 750 may be based, for example, on a reduced slip provided between the media 730 and the upstream media advance mechanism 710 during the media 730 advance, or as another example, by providing a stepper motor or an encoder to precisely control the upstream media advance mechanism 710. Such controlling of the upstream media advance mechanism 710 may be referred, in some examples, as an open-loop controlling. The open-loop controlling may represent a non-feedback type of control, where an output signal from the printer controller 760 to the upstream media advance mechanism 710 is not affected by feedback from sensors, for example, from the media advance sensor 750.

According to some examples, controlling should be understood as processing the position data received from the media advance sensor 750 at the printer controller 760, and providing a control signal to the media advance mechanism(s). In such examples, feedback from the media advance sensor 750 is provided. Some such examples of controlling will be explained later in the following paragraphs. Such controlling of a media advance mechanism may be referred, in some examples, as a closed-loop controlling.

The example method 100 comprises, in block 130, controlling, by the printer controller 760, the advance of the media 730 by a downstream media advance mechanism 720 located downstream from the print zone 740, during a second time period following the first time period and based on the received position data, whereby a trailing edge 735 of the media 730 passes between the upstream media advance mechanism 710 and the downstream media advance mechanism 720 during the second time period.

The downstream media advance mechanism 720 of the present disclosure should be understood as any type of advance mechanism that is capable to advance the media 730, located downstream from the print zone 740. In some examples, the downstream media advance mechanism 720 may comprise one or more of a roller, a drive wheel, a belt, and a conveyor. In some examples, the downstream media advance mechanism 720 may pick up the printed media 730 from the print zone 740 and advances the media 730 along the media advance direction. The downstream media advance mechanism 720 may be connected to the printer controller 760 wirelessly or by a wire to exchange digital or analog data with the printer controller 760, such data being related to the advance of the media 730.

According to one example, the upstream media advance mechanism 710 and the downstream media advance mechanism 720 may be the same types of advance mechanisms. According to another example, the upstream media advance mechanism 710 may differ from the downstream media advance mechanism 720. In one example, the upstream media advance mechanism 710 may be a roller and the downstream media advance mechanism 720 may be a conveyor. Other examples of the upstream media advance mechanism 710 and downstream media advance mechanism 720, independently combining any type of advance mechanisms, can be provided.

As noted previously, controlling should be understood according to one example, as processing the position data received from the media advance sensor 750 at the printer controller 760, and providing a control signal to the media advance mechanism(s). In such example, the advance (movement) of the media advance mechanism may be controlled by the printer controller 760 considering the received position data from the media advance sensor 750. For example, the printer controller 760 may process the received position data from the media advance sensor 750 and provide a control signal to the downstream media advance mechanism 720 to control its advance. Controlling the advance of the media advance mechanism using feedback from the media advance sensor 750 may, in some examples, demand more computing power than the controlling without the interaction of the media advance sensor 750. In some examples, controlling the media advance mechanism based on position data from the media advance sensor 750 may be used for various types of the media advance mechanisms in order to provide a desired level of precision in media advance control, and by consequence reach a relatively high-quality graphical representation on the media 730 during printing, such as, for example, by use of an overdrive media advance mechanism. An overdrive media advance mechanism may be understood, as a type of advance mechanism used downstream the print zone 740 to, for example, pick up the printed media 730 from the print zone 740 and advance the media 730 along the media advance direction. In some examples, the overdrive media advance mechanism may be a stacker media advance mechanism to collect the printed media 730 in a stacker. The stacker should be understood as an area for collecting the printed media 730 and to stack a certain quantity of the printed media 730.

The first time period should be understood, according to one example, as a period of time during which the upstream media advance mechanism 710 is controlled by the printer controller 760. In some examples, the first time period ends when the trailing edge 735 of the media 730 passes the upstream media advance mechanism 710 towards the downstream media advance mechanism 720. During the first time period, the upstream media advance mechanism 710 may primarily control the advance of the media 730 with a demanded precision to provide high-quality printing. In some examples, the upstream media advance mechanism 710 may be a single advance mechanism that provides the advance control of the media 730 during the first time period. According to some examples, open-loop controlling may be provided to the upstream media advance mechanism 710. In other examples, closed-loop controlling may be provided to the upstream media advance mechanism 710 using the position data received from the media advance sensor 750.

As noted previously, according to some examples, the first time period ends when the trailing edge 735 of the media 730 passes the upstream media advance mechanism 710 towards the downstream media advance mechanism 720. The end of the first time period can be thus defined as a moment when the trailing edge 735 of the media 730 loses contact with the upstream media advance mechanism 710. Once the first time period ends, the upstream media advance mechanism 710 may not provide the advance to the media 730 due to no traction being provided between the media 130 and upstream media advance mechanism 710. According to the present disclosure, the start of the first time period may be defined in different manners. According to one example, the first time period may start once a leading edge of the media 730 comes into contact with the upstream media advance mechanism 710. In other examples, the first time period can start at any time interval during the printing on the media 730 upon which the media 730 is in contact with the upstream media advance mechanism 710. Further examples may define the start of the first time period at any time interval during the printing on the media 730 upon which the trailing edge 735 of the media 730 is located upstream from the upstream media advance mechanism 710 along the media advance direction.

The second time period, according to the present disclosure, should be understood as a period of time that follows the first time period. According to one example, the second time period may be defined as a period of time during which the trailing edge 735 of the media 730 passes between the upstream media advance mechanism 710 and downstream media advance mechanism 720. According to the present disclosure, the second time period should be thus understood as a period of time during which the downstream media advance mechanism 720 is controlled by the printer controller 760 using the position data from the media advance sensor 750. During the second time period, the downstream media advance mechanism 720 may control the advance of the media 730 with a demanded precision to provide high-quality printing, for example based on a feedback loop from the media advance sensor 750. In some examples, the downstream media advance mechanism 720 may be a single advance mechanism providing advance control of the media 730 during the second time period.

According to one example, the second time period may start at the exact moment when the first time period ends. For example, the second time period starts when the trailing edge 735 of the media 730 passes the upstream media advance mechanism 710 towards the downstream media advance mechanism 720. The start of the second time period can be thus defined as a moment when the trailing edge 735 of the media 730 loses contact with the upstream media advance mechanism 710. Once the second time period starts, the upstream media advance mechanism 710 may not provide the advance to the media 730 due to no traction being provided between the media 130 and upstream media advance mechanism 710. According to some examples, the end of the second time period may be defined as a period of time when the trailing edge 735 of the media 730 passes the downstream media advance mechanism 720 downstream from the print zone 740. The end of the second time period can be thus defined as a moment when the trailing edge 735 of the media 730 loses contact with the downstream media advance mechanism 720. Once the second time period ends, the downstream media advance mechanism 720 may not provide the advance to the media 730 due to no traction provided between the media 130 and downstream media advance mechanism 720. In some examples, the end of the second time period may be defined as a moment when the trailing edge 735 of the media 730 passes the downstream of the print zone 740 such that no more printing occurs. In such example, the advance of the media 730 may be of lesser accuracy when no more printing occurs.

As the second time period follows the first time period, the present disclosure can, in some examples, comprise a dynamic switch between the controlling of the upstream media advance mechanism 710 and the controlling of the downstream media advance mechanism 720 based on the received position data from the media advance sensor 750. As the downstream media advance mechanism 720 may be controlled in the second time period based on the received position data from the media advance sensor 750, precise media 730 advance may be maintained in cases of the upstream media advance mechanism 710 losing contact with the media 130. Once the upstream media advance mechanism 710 does not provide the advance of the media 730, precise printing on the media 730 may be provided on the trailing edge 735 of the media 730 since the precise advance of the media 730 may have dynamically switched and be controlled by the downstream media advance mechanism 720.

According to another example, the example method 100 may further comprise controlling, by the printer controller 760, the advance of the media 730 by the upstream media advance mechanism 710 during the first time period based on the received position data. According to this example, controlling during the first period should be understood as processing the position data received from the media advance sensor 750 at the printer controller 760, and providing a control signal to the upstream media advance mechanism 710 accordingly. During the first time period, the upstream media advance mechanism 710 may control the advance of the media 730 with the demanded precision to provide high-quality printing, for example based on a feedback loop from the media advance sensor 750. According to this example, the upstream media advance mechanism 710 may use the feedback loop from the media advance sensor 750 to correct advancing errors of the media 730. According to another example, the feedback loop from the media advance sensor 750 can be used as a control mechanism to verify the position of the media 730 within the print zone 740.

FIG. 2 illustrates an example method 200. Example method 200 comprises blocks 110, 120, and 130 as described, for example, in the context of example method 100. Example method 200 of the present disclosure may, for example, be operated using any of example printers 700, 800, 900, 1000 or 1100 described in FIGS. 7 to 11.

Example method 200 further comprises in block 225, correcting, by the printer controller 760, a position error of the media 730 by the upstream media advance mechanism 710 during the first time period. Correcting should be understood, according to the present disclosure, as correcting the advance of the media 730 within the print zone 740 by for example, adaptation of the advance of the media advance mechanism, for example by reducing or accelerating a media advance rate. In one example, the printer controller 760 may provide a control signal directly to the upstream media advance mechanism 710 without the feedback loop of received position data from the media advance sensor 750. In another example, the printer controller 760 may provide a control signal to the upstream media advance mechanism 710, as a function of the received position data from the media advance sensor 750. By correcting the position error of the media 730, a high-quality graphical representation having undesired artifacts may be provided.

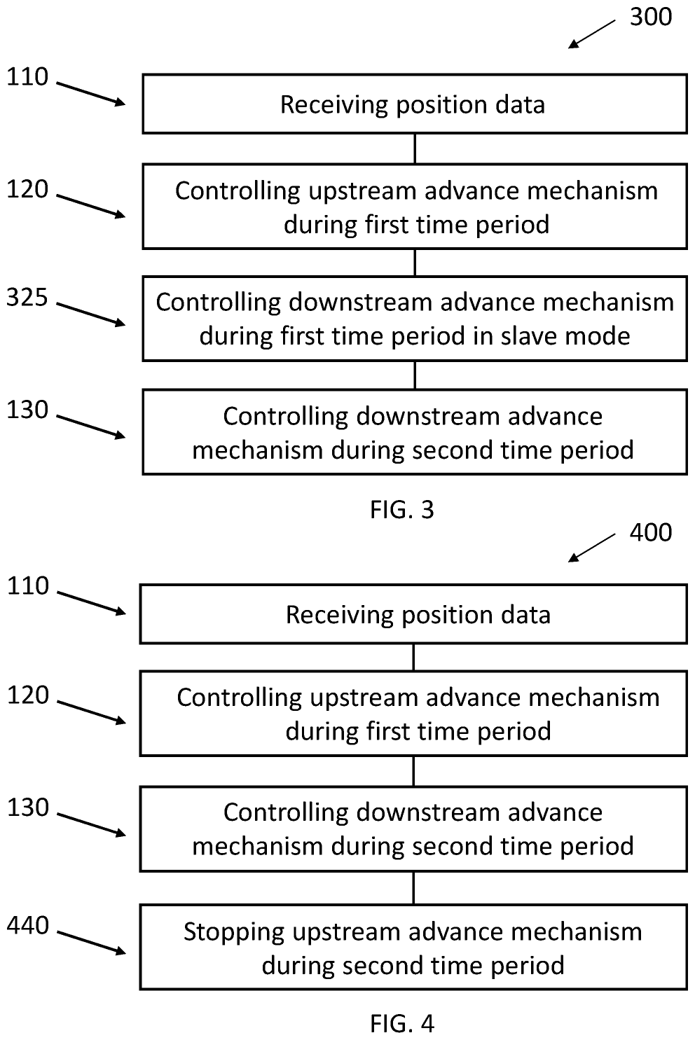

FIG. 3 illustrates an example method 300. Example method 300 comprises blocks 110, 120, and 130 as described, for example, in the context of example method 100. While not represented here, example method 300 may further comprise a block such as block 225 of example method 200. Example method 300 of the present disclosure may, for example, be operated using any of example printers 700, 800, 900, 1000 or 1100 described in FIGS. 7 to 11.

Example method 300 further comprises in block 325, operating, by the printer controller 760, the advance of the media 730 by the downstream media advance mechanism 720 during the first time period in a slave mode. In some examples, the downstream media advance mechanism 720 may be operated in the first time period by the printer controller 760, as the printer controller 760 may simultaneously control the upstream media advance mechanism 710. In some examples, the simultaneous controlling of the upstream media advance mechanism 710 and operating of the downstream media advance mechanism 720 may be provided based on the priorities given by the printer controller 760. For example, during the first time period, the printer controller 760 may operate the downstream media advance mechanism 720 in the slave mode, whereas the upstream media advance mechanism 710 may be controlled in a master mode. While controlling should be understood as providing a control signal from the printer controller 760 to the media advance mechanism(s) in order to reach a desired media advance precision, operating should be understood as advancing a media using a media advance mechanism. In a master/slave mode, while control relates to a master mode, operation relates to a slave mode. Using a master/slave mode can prevent creating mechanical tensions on the media in case of simultaneously controlling two different media advance mechanism o a same media sheet, such simultaneous control leading in some examples to undesired media stretching or to an undesirably lose media between such two different media advance mechanisms. In a related manner, in some examples the first and the second periods of time do not overlap.

The master mode should be understood as a mode of operation of the media advance mechanism, that primarily receives the control signal from the printer controller 760. The media advance mechanism that operates in the master mode may be called a master media advance mechanism. In the master mode, the master media advance mechanism may be controlled by the printer controller 760, while the media advance mechanism in the slave mode may, or may not be in operation. In some examples, the advance of the media 730 operated by the media advance mechanism in the slave mode may be synchronized with the advance control of the media advance mechanism in the master mode. In some examples, the advance of the downstream media advance mechanism 720 in the slave mode may be synchronized with the advance of the upstream media advance mechanism 710. The slave mode should be understood as a mode of operation of the media advance mechanism, that receives the operating signal from the printer controller 760 in response to the control of the media advance mechanism in the master mode. The media advance mechanism that operates in the slave mode may be called a slave media advance mechanism. In some examples, the printer controller 760 may operate the slave media advance mechanism when the master media advance mechanism is being controlled. In some examples, the printer controller 760 may operate the slave media advance mechanism while the master media advance mechanism is stopped.

Accordingly, in some examples, the downstream media advance mechanism 720 may be operated in response to the control of the upstream media advance mechanism 710, for example during the first period of time. In some examples, the printer controller 760 may control the advance of the downstream media advance mechanism 720 while the upstream media advance mechanism 710 is, or remains, in operation, for example during the second period of time. In some examples, the printer controller 760 may control the advance of the downstream media advance mechanism 720 while the upstream media advance mechanism 710 is stopped, for example during the second period of time. In some examples, during the first time period, the advance of the media 730 may be controlled by the upstream media advance mechanism 710 while the downstream media advance mechanism 720 is operated based on the advance rate of the upstream media advance mechanism 710.

FIG. 4 illustrates an example method 400. Example method 400 comprises blocks 110, 120, and 130 as described, for example, in the context of example method 100. While not represented here, example method 400 may further comprise one or more of blocks such as block 225 of example method 200 and block 325 of example method 300. Example method 400 of the present disclosure may, for example, be operated using any of example printers 700, 800, 900, 1000 or 1100 described in FIGS. 7 to 11.

Example method 400 further comprises in block 440, stopping, by the printer controller 760, the upstream media advance mechanism 710 during the second time period. As referred above, in some examples, during the second time period the trailing edge 735 of the media 730 passes between the upstream media advance mechanism 710 and downstream media advance mechanism 720. For example, during the second time period, the trailing edge 735 of the media 730 may pass the upstream media advance mechanism 710 towards the downstream media advance mechanism 720 and the media 730 may lose contact with the upstream media advance mechanism 710. The upstream media advance mechanism 710 may not then provide the advance to the media 730 due to the absence of traction provided between the media 130 and the upstream media advance mechanism 710. Consequently, the printer controller 760 may stop the upstream media advance mechanism 710 as no contact between the media 730 and the upstream media advance mechanism 710 occurs. Accordingly, in some examples, the downstream media advance mechanism 720 may be a single advance mechanism providing advance control of the media 730 during the second time period.

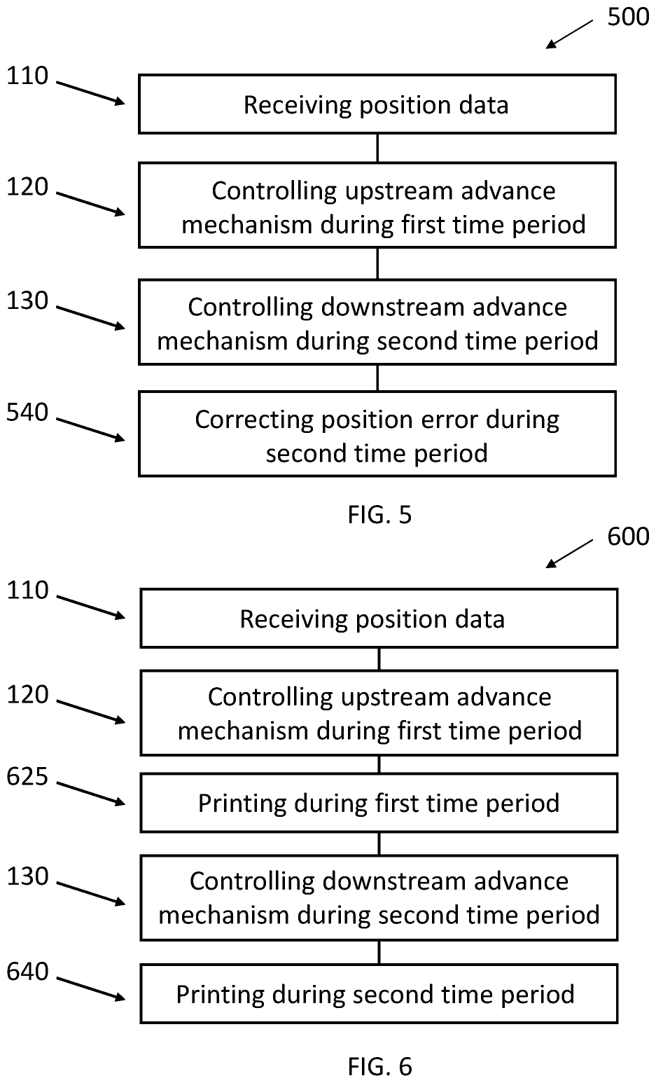

FIG. 5 illustrates an example method 500. Example method 500 comprises blocks 110, 120, and 130 as described, for example, in the context of example method 100. While not represented here, example method 500 may further comprise one or more of blocks such as block 225 of example method 200, block 325 of example method 300, and block 440 of example method 400. Example method 500 of the present disclosure may, for example, be operated using any of example printers 700, 800, 900, 1000 or 1100 described in FIGS. 7 to 11.

Example method 500 further comprises in block 540, correcting, by the printer controller 760, a position error of the media 730 by the downstream media advance mechanism 720 during the second time period. As referred above in some examples, correcting should be understood as correcting the advance of the media 730 within the print zone 740 by, for example, adaptation of the advance of the media advance mechanism, for example by reducing or accelerating a media advance rate. By correcting the position error of the media 730, a high-quality graphical representation having a reduced amount of, or no undesired artifacts, may be provided. In some examples, the printer controller 760 may provide a control signal to the downstream media advance mechanism 720, as a function of the received position data from the media advance sensor 750.

FIG. 6 illustrates an example method 600. Example method 600 comprises blocks 110, 120, and 130 as described, for example, in the context of example method 100. While not represented here, example method 600 may further comprise one or more of blocks such as block 225 of example method 200, block 325 of example method 300, block 440 of example method 400, and block 540 of example method 500. Example method 600 of the present disclosure may, for example, be operated using any of example printers 700, 800, 900, 1000 or 1100 described in FIGS. 7 to 11.

Example method 600 further comprises in blocks 625 and 640 respectively, printing, by a printhead 770, on the media 730 during the first and second time period. Printing may take place, for example by applying the printing fluid onto the media 730. In some examples, printing fluid may be applied to the media in the print zone 740 when printing. The printhead such as example printhead 770 should be understood as a device permitting ejecting a printing fluid, e.g., ink on the media 730. Example printheads include inkjet printheads, for example piezo or thermal inkjet printheads. In some examples, the printing fluid is a latex-based ink which is particularly suited for printing on different media 730 and may be suitable to be exposed to external weather conditions. In other examples, the printing fluid may be a non-marking fluid such as, e.g., an overcoat, a fixer, pretreatment, or post-treatment fluid which may be transparent and serve to prepare the media 730 for receiving an ink, or serve to fix an ink onto the media 730. In some examples, the printhead 770 should be understood as a device comprising a plurality of nozzles for ejecting a fluid on a media 730.

In some examples, the printhead 770 may be a scanning printhead or a Page-Wide-Array (PWA) printhead. A scanning printhead should be understood as a reciprocating printhead moving back and forth along a scanning direction that is at an angle to the media advance direction, for example at an angle of 90 degrees. In some examples, the area covered by the scanning printhead may be considered as the print zone 740. In some examples, the print zone 740 is comprised on a platen 1010 as illustrated for example in FIG. 10. The scanning printhead may travel across such platen 1010 along the scanning direction. A PWA printhead should be understood as a static printhead. In some examples, the area covered by the PWA printhead may be considered as the print zone 740. In some examples, the PWA printhead may be positioned all across the print zone 740 at an angle to the media advance direction, for example at an angle of 90 degrees.

In some examples, the media 730 may be placed in the print zone 740 in order to receive the printing fluid from a scanning printhead 770 to form a graphical representation as the printhead 770 may scan across the print zone 740. In some examples, printing along the media 730 may take place by relative movement of the media 730 and of the print zone 740, such relative movement following for example the media advance direction at an angle to the scanning direction.

According to another example, any of the example methods 100-600 may further comprise receiving the position data by the media advance sensor 750 based on one or more of: a position of the leading edge of the media 730, a position of the trailing edge 735 of the media 730, or a surface movement of the media 730. As referred above, in some examples, the media advance sensor 750 should be understood as any sensor that measures the advance (movement) of the media 730 while the media 730 advances through the print zone 740.

In some examples, the media advance sensor 750 may be located above or below the moveable media 730. For example, the media advance sensor 750 may be located below the print zone 740, between the upstream media advance mechanism 710 and the downstream media advance mechanism 720. In some examples, the media advance sensor 750 may be located below the platen 1010, at any position across the platen 1010 in the media advance direction. In some examples, the media advance sensor 750 may be located below the print zone 740, downstream from the downstream media advance mechanism 720 in the media advance direction. In some examples, the media advance sensor 750 may be located above the print zone 740, between the upstream media advance mechanism 710 and the downstream media advance mechanism 720. In some examples, the media advance sensor 750 may be located above the print zone 740, downstream from the downstream media advance mechanism 720 in the media advance direction. In some examples, the media advance sensor 750 may be located above the print zone 740, upstream from the upstream media advance mechanism 710 in the media advance direction. In examples whereby the media advance sensor is an optical sensor, at least part of the print zone should be comprised in a field of view of the optical sensor. In examples whereby the media advance sensor is a mechanical sensor, at least part of the mechanical sensor should be in contact with at least part of a media in the print zone.

According to some examples, the media advance sensor 750 may receive the position of the leading edge of the media 730. In some examples, the media advance sensor 750 may receive the position of the trailing edge 735 of the media 730. In some examples, the media advance sensor 750 may receive surface movement of the media 730, such as a position of any part of the media 730 to determine the advancing of the media 730 within the print zone 740.

FIG. 7 illustrates an example printer 700 of the present disclosure which may, for example, perform any of the example methods 100-600 previously described. The printer should be understood as a device to reproduce a graphical representation onto the media 730. The printer 700 may operate according to different printing technologies. In some examples, the printer may be a thermal ink jet printer. In some examples, the printer may be a piezo ink jet printer. In some examples, the printer may be configured to eject an aqueous printing fluid. In some examples, the printer may be configured to eject a printing fluid comprising an organic solvent. In some examples, the printer may be configured to eject a printing fluid comprising a latex-based solvent. In some examples, the printer may be configured to eject a UV (ultraviolet) curable printing fluid.

Referring to FIG. 7, the printer 700 comprises the upstream media advance mechanism 710 located upstream from the print zone 740 to advance the media 730 during the first time period, the downstream media advance mechanism 720 located downstream from the print zone 740 to advance the media 730 during the second time period following the first time period, the media advance sensor 750 to sense a position of the media 730, and the printer controller 760 to control the upstream media advance mechanism 710 during the first time period, and control the downstream media advance mechanism 720 during the second time period based on the position of the media 730, wherein the second time period starts once the trailing edge 735 of the media 730 passes through the upstream media advance mechanism 710.

The upstream media advance mechanism 710 and the downstream media advance mechanism 720, as described above, may each comprise one or more of a roller, a drive wheel, a belt, and a conveyor. In example printer 700 shown in FIG. 7, the upstream media advance mechanism 710 and the downstream media advance mechanism 720 are rollers.

In example printers 700, 800, 900, 1000 or 1100 described herewith, the upstream media advance mechanism 710, downstream media advance mechanism 720, media 730, print zone 740, media advance sensor 750, printer controller 760, first time period, and the second time period may correspond to the definitions as previously described. For example, the printer controller 760 may comprise the processor 761 and the memory 762.

As shown in example of FIG. 7, the media advance sensor 750 may be located above the print zone 740, upstream from the upstream media advance mechanism 710 in the media advance direction. Other positions of the media advance sensor 750, as explained above, are possible. In example shown in FIG. 7, the print zone 740 is located between the upstream media advance mechanism 710 and the downstream media advance mechanism 720.

In some examples, the sensor 750 may be connected to the printer controller 760 wirelessly or by a wire to exchange digital or analog data with the printer controller 760, such data being related to the advance of the media 730. In some examples, the upstream media advance mechanism 710 may be connected to the printer controller 760 wirelessly or by a wire to exchange digital or analog data with the printer controller 760, such data being related to the advance of the media 730. In some examples, the downstream media advance mechanism 720 may be connected to the printer controller 760 wirelessly or by a wire to exchange digital or analog data with the printer controller 760, such data being related to the advance of the media 730.

As shown in FIG. 7, example printer 700 further comprises a printhead 770 disposed between the upstream media advance mechanism 710 and the downstream media advance mechanism 720. The printhead 770, as shown in example printer 700, may be a printhead as described for example above. In some examples, the printhead 770 may be located at any position, between the upstream media advance mechanism 710 and the downstream media advance mechanism 720. The printhead is to print on the media during the first time period and during the second time period. Such printing during both the first and the second time periods is enabled by control of the position of the media in the print zone by the upstream media advance mechanism during the first time period, and by control of the position of the media in the print zone by the downstream media advance mechanism during the first time period.

FIG. 8 illustrates an example printer 800 of the present disclosure which may, for example, perform any of the example methods 100-600 previously described. Example printer 800 comprises all the features as described, for example, in the context of example printer 700.

The upstream media advance mechanism 710, as shown in FIG. 8, is, for example, one or more of a belt and a conveyor. In the example of FIG. 8, the downstream media advance mechanism 720 is a roller. The example printer 800, as shown in FIG. 8 may further comprise one or more tension mechanisms 820 that in some examples, may form a roll-to-roll configuration with one or both the upstream media advance mechanism 710 and the downstream media advance mechanism 720. The roll-to-roll configuration should be understood in that the media 730 is pinched between different mechanisms such as, for example, between the upstream media advance mechanism 710 and the tension mechanism 820, and between the downstream media advance mechanism 720 and the tension mechanism 820. In some examples, the tension mechanism 820 may be positioned substantially above the media advance mechanism. In some examples, the tension mechanism 820 may comprise one or more of a roller, a drive wheel, a belt, and a conveyor. In example shown in FIG. 8, the tension mechanism 820 is, for example, a roller or a drive wheel.

As shown in example of FIG. 8, the media advance sensor 750 may be located below the print zone 740, downstream from the downstream media advance mechanism 720 in the media advance direction. Other positions of the media advance sensor 750, as explained above, are possible.

The example printer 800, as shown in FIG. 8 further comprises a media input zone 830 located upstream from the upstream media advance mechanism 710. The media input zone 830, for example an input tray for cut sheets, should be understood as an area within the printer, where media 730 to be printed is located.

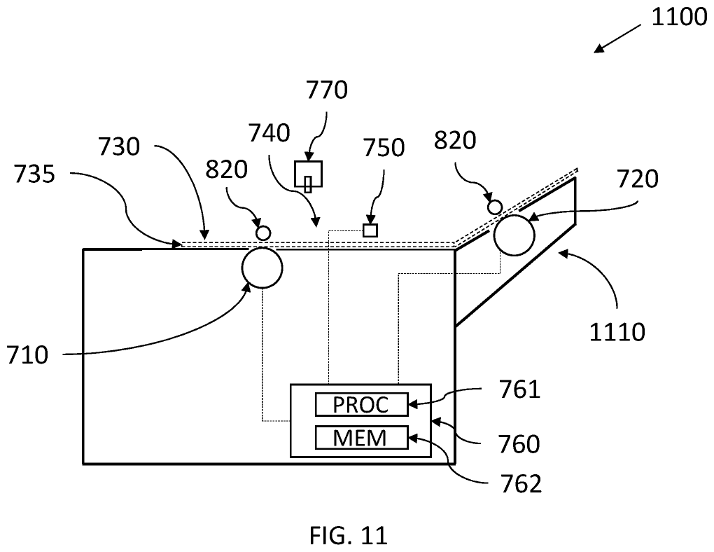

According to another example of the example printers 700, 800, 900, 1000 or 1100 described herewith, the downstream media advance mechanism 720 is an overdrive roller of the printer. An overdrive roller may be understood as a type of roller (media advance mechanism) used downstream from the print zone 740 to, for example, pick up the printed media 730 from the print zone 740 and advance the media 730 along the media advance direction. In some examples, the overdrive roller may be a stacker roller to collect the printed media 730 in a stacker 1110 as illustrated for example in FIG. 11. As previously described, the stacker 1110 should be understood as an area for collecting the printed media 730 and to stack a certain quantity of the printed media 730.

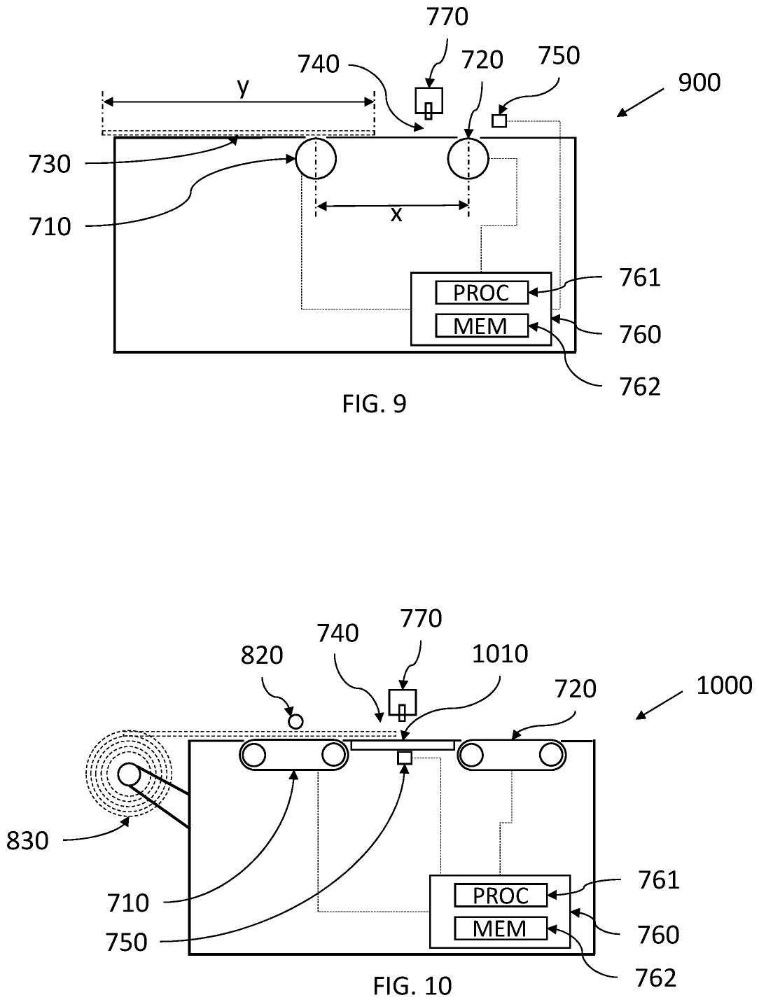

FIG. 9 illustrates an example printer 900 of the present disclosure which may, for example, perform any of the example methods 100-600 previously described. Example printer 900 may comprise one or more features as described, for example, in the context of example printer 700. While not represented here, example printer 900 may further comprise one or more features of example printer 800. As shown in FIG. 9, a distance x between the upstream media advance mechanism 710 and the downstream media advance mechanism 720 is equal to, or less than a length y of the media 730 in an upstream-downstream direction. The upstream-downstream direction should be understood as the media advance direction described, for example, above.

In some examples, as the length y of the media 730 is equal to, or more than the distance x between the upstream and downstream media advance mechanism 710-720, there is at least one media advance mechanism that advances the media 730 across the print zone 740. Accordingly, the media 730 during its advance across the print zone 740 will not be stuck due to a lack of media advance control, and the printing is provided to the desired area of the media 730.

As shown in FIG. 9, the media advance sensor 750 may be located above the print zone 740, downstream from the downstream media advance mechanism 720 in the media advance direction. Other positions of the media advance sensor 750, as explained above, are possible. In example printer 900 shown in FIG. 9, the upstream media advance mechanism 710 and the downstream media advance mechanism 720 are rollers. Other types of media advance mechanisms, as for example described above, may be possible.

FIG. 10 illustrates an example printer 1000 of the present disclosure which may, for example, perform any of the example methods 100-600 previously described. Example printer 1000 may comprise one or more features as described, for example, in the context of example printer 700. While not represented here, example printer 1000 may further comprise one or more features of example printer 800 and 900. As shown in FIG. 10, the print zone 740 comprises the platen 1010, wherein the media advance sensor 750 is located below the platen 1010. The platen 1010 should be understood as a device to hold the media 730 within the print zone 740. In some examples, the platen 1010 defines the print zone 740. Accordingly, the print zone 740 may comprise, in some examples, the printing area on the platen 1010 which is reachable by the printhead 770 to apply the printing fluid onto the media 730. In some examples, the print zone 740 may comprise a flat platen 1010, as shown in FIG. 10. In some examples, the print zone 740 comprises a roller-shaped or a curved platen.

The example printer 1000, as shown in FIG. 10 may further comprise a media input zone 830 as defined for example above. The media input zone 830 may comprise, for example, a roll of media 730 located upstream from the upstream media advance mechanism 710. The upstream media advance mechanism 710 and the downstream media advance mechanism 720, as shown in FIG. 10, are, for example, one or more of a belt and a conveyor. In some examples shown in FIG. 10, a single tension mechanism 820 is provided, being located substantially above the upstream media advance mechanism 710. It should be understood that media from a roll of media may be cut by a cutter to generate a trailing edge.

FIG. 11 illustrates an example printer 1100 of the present disclosure which may, for example, perform any of the example methods 100-600 previously described. Example printer 1100 may comprise one or more features as described, for example, in the context of example printer 700. While not represented here, example printer 1100 may further comprise one or more features of example printer 800, 900, and 1000. As shown in FIG. 11, example printer 1100 comprises a stacker 1110 located downstream from the downstream media advance mechanism 720, whereby the stacker 1110 comprises the downstream media advance mechanism 720. As described in some examples above, the stacker 1110 should be understood as an area for collecting the printed media 730 and to stack a certain quantity of the printed media 730. In example shown in FIG. 11, the downstream media advance mechanism 720 may pick up the printed media 730 from the print zone 740 and advance the media 730 along the media advance direction into the stacker 1110.

As shown in FIG. 11, the media advance sensor 750 may be located above the print zone 740, between the upstream and downstream media advance mechanism 710-720. Other positions of the media advance sensor 750, as explained above, are possible. In example printer 1100 shown in FIG. 11, the upstream media advance mechanism 710 and the downstream media advance mechanism 720 are rollers. Other types of media advance mechanisms, as for example described above, may be possible. In example printer 1100 shown in FIG. 11, two tension mechanisms 820 as described above, form the roll-to-roll configuration with the upstream media advance mechanism 710 and the downstream media advance mechanism 720.

In some examples of the present disclosure, the non-transitory machine-readable storage medium 762 encoded with instructions executable by the processor 761 is provided. The non-transitory machine-readable storage medium 762 comprises instructions to receive, at the printer controller 760 and from the media advance sensor 750, position data of the media 730 progressing within the print zone 740. The non-transitory machine-readable storage medium 762 comprises instructions to control, by the printer controller 760, a progress of the media 730 by the upstream media advance mechanism 710 placed upstream from the print zone 740 during the first time period. The non-transitory machine-readable storage medium 762 comprises instructions to control, by the printer controller 750, the progress of the media 730 by the downstream media advance mechanism 720 placed downstream from the print zone 740 during the second time period following the first time period and based on the position data, wherein the first time period ends as the trailing edge 735 of the media 730 passes through the upstream media advance mechanism 710.

As for example described above, the non-transitory machine-readable storage medium 762 may comprise the memory 762, whereby the memory 762 is encoded with instructions executable by the processor 761. In some examples, the printer controller 760 comprises the processor 761 and the memory 762. In some examples, the processor 761 is configured to operate according to any of the methods 100-600 hereby described. In some examples, the non-transitory machine-readable storage medium 762 may be incorporated in any of the printers 700, 800, 900, 1000 or 1100 described herewith.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method comprising:
receiving, at a printer controller and from a media advance sensor, position data of a media that is at least partially positioned within a print zone;
controlling, by the printer controller, and during a first time period, an advance of the media by an upstream media advance mechanism located upstream from the print zone; and
controlling, by the printer controller, and during a second time period following the first time period, the advance of the media by a downstream media advance mechanism located downstream from the print zone, based on the received position data;
wherein a trailing edge of the media passes between the upstream media advance mechanism and the downstream media advance mechanism during the second time period.

2. The method in accordance with claim 1 comprising: controlling, by the printer controller, the advance of the media by the upstream media advance mechanism during the first time period based on the received position data.

3. The method in accordance with claim 2 comprising: correcting, by the printer controller, a position error of the media by the upstream media advance mechanism during the first time period.

4. The method in accordance with claim 1 comprising: operating, by the printer controller, the advance of the media by the downstream media advance mechanism during the first time period in a slave mode.

5. The method in accordance with claim 1 comprising: stopping, by the printer controller, the upstream media advance mechanism during the second time period.

6. The method in accordance with claim 1 comprising: correcting, by the printer controller, a position error of the media by the downstream media advance mechanism during the second time period.

7. The method in accordance with claim 1 comprising: printing, by a printhead, on the media during the first and second time period.

8. The method in accordance with claim 1, wherein receiving the position data by the media advance sensor is based on one or more of:
a position of a leading edge of the media;
a position of the trailing edge of the media; or
a surface movement of the media.

9. A printer comprising:
an upstream media advance mechanism located upstream from a print zone to advance a media during a first time period;
a downstream media advance mechanism located downstream from the print zone to advance the media during a second time period following the first time period;
a media advance sensor to sense a position of the media;
a printer controller to control the upstream media advance mechanism during the first time period, and control the downstream media advance mechanism during the second time period based on the position of the media, wherein the second time period starts once a trailing edge of the media passes through the upstream media advance mechanism; and
a printhead disposed between the upstream media advance mechanism and the downstream media advance mechanism to print on the media during the first time period and during the second time period.

10. The printer in accordance with claim 9, comprising a media input zone located upstream from the upstream media advance mechanism.

11. The printer in accordance with claim 9, wherein the downstream media advance mechanism is an overdrive roller of the printer.

12. The printer in accordance with claim 9, wherein a distance between the upstream media advance mechanism and the downstream media advance mechanism is equal to, or less than a length of the media in an upstream-downstream direction.

13. The printer in accordance with claim 9, wherein the print zone comprises a platen, wherein the media advance sensor is located below the platen.

14. The printer in accordance with claim 9, wherein the printer comprises a stacker located downstream from the downstream media advance mechanism, whereby the stacker comprises the downstream media advance mechanism.

15. A non-transitory machine-readable storage medium encoded with instructions executable by a processor, the non-transitory machine-readable storage medium comprising:
instructions to receive, at a printer controller and from a media advance sensor, position data of a media progressing within a print zone;
instructions to control, by the printer controller, a progress of the media by an upstream media advance mechanism placed upstream from the print zone during a first time period;
instructions to control, by the printer controller, the progress of the media by a downstream media advance mechanism placed downstream from the print zone during a second time period following the first time period and in function of the position data, wherein the first time period ends as a trailing edge of the media passes through the upstream media advance mechanism.
